(19) United States
(12) Patent Application Publication
(10) Pub. No.: US 2017/0026333 A1
(43) Pub. Date: Jan. 26, 2017

(54) METHODS AND SYSTEMS FOR A UNIFIED MULTI-MEDIA COMMUNICATIONS SYSTEM

(71) Applicant: Satyan G. Pitroda, Oak Brook, IL (US)

(72) Inventor: Satyan G. Pitroda, Oak Brook, IL (US)

(21) Appl. No.: 15/067,743

(22) Filed: Mar. 11, 2016

Related U.S. Application Data
(60) Provisional application No. 62/131,757, filed on Mar. 11, 2015.

(51) Int. Cl. H04L 12/58

(52) U.S. Cl. CPC H04L 51/36; H04L 51/16; H04L 51/046; H04L 51/06; H04L 51/32; H04L 51/38; H04L 51/14; H04L 51/04

(57) ABSTRACT

Methods and systems for integrated communications using multi-media channels of communication. The disclosure relates to enabling multi-media communication among users through multiple and varied communication channels using a single interface. The method and system for integrated communication allows users to communicate through multiple channels, without requiring the users to leave the interface, using a robust information set that is enabled by multi-media capabilities. A single interface is provided to allow users to use to communicate to other users through a variety of communication channels. This is assisted by an integration engine that integrates multiple communication channels, as well as a context engine, which allows a user to send context, as well as resources, through the communication channels.

### RELATED APPLICATIONS

This application claims priority to U.S. Patent Application 62/131,757, filed Mar. 11, 2015, and which is hereby incorporated by reference in its entirety.

### FIELD OF THE INVENTION

The disclosure generally relates to providing methods and systems for integrated communications using a unified multi-media communication system. More specifically, the disclosure relates to enabling communication among users through multiple and varied communication channels using a multi-media system.

### BACKGROUND OF THE INVENTION

Current electronic communication systems, email in particular, were designed many years ago. Since that time, the manner and channels through which people communicate have significantly evolved. This evolution has been enabled by the use of communication platforms and channels, made possible by the widespread availability of high speed connectivity, both wired and wireless, that were not contemplated when many current electronic communication systems were designed. Today, communication platforms take many forms, and a great deal of communication is performed among users of mobile devices, rather than desktop computers, for example. Communication channels today are varied in purpose, use patterns, and capability, while enabling multi-media communication streams. Many of these communication channels, such as social media networks, were not yet available when many older communication systems were designed.

Many of these communication channels require users to communicate through interfaces that are specific to a single communication channel or application, such as email, a social networking application like Facebook®, SnapChat® or Twitter®, a conferencing application like Join.me®, Webex® or GotoMeeting®, an SMS or chat application (such as on the desktop or on a mobile device), a video application like Skype® or Facetime® or the like, a voice call (including by IP telephony, conventional wireline, or cellular), a text or the like. Users can also communicate by file transfers, such as by placing materials and messages in public cloud storage sites like Dropbox®, Box® and the like, then sharing access. Users can also use cloud-based messaging services, like Telegram™. User can also communication within applications, such as online multi-player gaming applications.

Users typically have to switch back and forth among these applications, using one of them at a time. This takes time and tends to cause users to lose communications threads (e.g., email threads, or chains of posts), or the related context, as they do so. Some of these communication channels are now able to present information via methods that communication systems designed many years ago were not able to present. However, the benefits seen in some systems are not available in others, and certain channels are preferred for some kinds of communications, while other channels are preferred for others. Therefore, a need exists for improved methods and systems for communications across heterogeneous communications channels and applications, such as methods and systems that integrate communications, maintain context, and take advantage of all of the features and benefits of newer communications channels and applications.

### SUMMARY

Provided herein are methods and systems for integrated communications that allow users to communicate through multiple, heterogeneous channels, using a single interface, maintaining the context of the user, as well as threads of communication, and using a robust information set and other features that are enabled by multi-media communications capabilities. The integration of the heterogeneous communications channels to a single interface may alternatively be referred to as using a wrapper, a container or similar terms. These terms, as used herein, refer generally to a data structure, in this case related to a communication or collection or thread of communications, that contains the communication(s) and also can include other elements, such as elements relating to the context of the user, the context of the application, contact details for a sender and/or recipient, and information about other communication channels by which a user can be contacted. In one embodiment, a container operates with a single operating system and includes one or apps, such as a Docker container. The container may also include one or more bins or libraries useful for the apps.

In embodiments the container allows inclusion of elements that reflect the entire context of a user's communications and the user's communications capabilities. For example, a user may have multiple email accounts, social networking accounts, video conferencing and web conferencing contexts, cloud storage accounts, text messaging numbers, SMS handles, and the like. A container may include the entire communications context of the user, such as all of the above types of applications, services and capabilities, including the contact information for the user for each of the accounts of different types. A recipient of a communication carried by a container thus receives not only the latest message, but is presented, via the container, with the ability to reply to the sender via any of the different communications channels, without leaving the interface in which the original communication was received.

For example, a user may receive an email in a graphical user interface, where the recipient sees not only the email content, but all of the related social networking, email, conferencing, chat, and storage contacts by which the recipient can reach the sender, so the recipient can reply to the email by any of these methods. In an example, the recipient may decide to reply to the email by sending a text message. In turn, the reply container will contain the text message, preserve the original email so that the communications are related in a thread (even though one is an email and the other is a text) and include the entire communications context (various communications applications, services and capabilities with contact details) of the first recipient, so that the original sender (or other recipients to which the first recipient might forward the communication(s) thread) can reply to the original recipient by any contact method that corresponds to the recipient. For example, the original sender may now reply to the text with a link to an item in the file storage box of the recipient, which still preserves the original email and text when accessed via the interface. Such communications may continue, with a container preserving the contact channels and linking each subsequent communication in a thread across the different applications and preserving the thread and communications context of each user along the way.

As used herein the term “communications context,” sometimes referred to simply as the “context” of the user or sender or recipient, or the like, should be understood to encompass, except where the description indicates otherwise, the user's collection of communications applications, services, capabilities, and channels, including contact information for the various accounts, by which a user communicates and can receive communication.

Provided herein are methods and systems for a secure container for managing a plurality of heterogeneous communications capabilities of a sender, wherein upon relaying a user communication via one of the capabilities, the container accesses content and capabilities for and presents to a recipient, in a unified user interface, interface features that enable the recipient to respond to the sender via any one or more of the heterogeneous communications capabilities without requiring the recipient to navigate to a different application.

### BRIEF DESCRIPTION OF THE FIGURES

The accompanying figures and the detailed description below are incorporated in and form part of the specification, serving to further illustrate various embodiments and to explain various principles and advantages in accordance with the systems and methods disclosed herein.

FIG. 1 illustrates various components of an architecture for integrated communications in accordance with an embodiment of the systems and methods disclosed herein.

FIGS. 2A-2B illustrate uses of integrated communications in accordance with an embodiment of the systems and methods disclosed herein.

FIGS. 3A-3E illustrate examples of integrated communications in accordance with an embodiment of the systems and methods disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the systems and methods disclosed herein.

### DETAILED DESCRIPTION OF THE INVENTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art. The claims should be consulted to ascertain the true scope of the disclosure.

Before describing in detailed embodiments that are in accordance with the systems and methods disclosed herein, it should be observed that the embodiments reside primarily in combinations of method steps and/or system components related to enabling a user to communicate with another user. Accordingly, the system components and method steps have been represented where appropriate by conventional symbols in the drawings, showing only those specific details that are pertinent to understanding the embodiments of the systems and methods disclosed herein so as not to obscure the disclosure with details that will be readily apparent to those of ordinary skill in the art having the benefit of the description herein.

Disclosed herein are systems and methods for integrated communications using a unified multi-media communications system. The methods and systems for integrated communications may provide fast, flexible, convenient, reliable and secure communications. Communications may be secured using public key infrastructure (PKI) or other encryption method. PKI may be used for encoding messages and integrated communications described herein. A user of integrated communications according to the present disclosure may have a public key, such as a PKI public key. Integrated communications may include the PKI public key of a user enclosed in the communication. Integrated communications according to the present disclosure may automatically encrypt a message using a public key enclosed in the message or otherwise available to the user. A user using integrated communications according to this disclosure may decrypt a message using a private key not enclosed in the communications. Other encryption and decryption methods may also be used.

Communications according to the present disclosure may provide integrated communications by integrating communication channels and/or applications, such as by wrapping them, and associated individual communications or communication threads, in a secure container or wrapper. Communication channels or applications may include email, social media, text, chat, instant messaging, video conferencing, voice, file transfer, file sharing, cloud-based messaging, and/or other suitable channels, services, capabilities and/or applications. A method and system for integrated communications may support creation and transmission of communication content. Communication content may include text or visual communication content, audio or voice communication content (including VOIP), video communication content (including video files and streaming video), animation communication content, files of various formats, symbols (e.g., emojis) and other content as desired.

In embodiments, integrated communications may include a special container format, such as, in one embodiment, a letterhead or template format. The special container formatting may enable a plurality of formatting characteristics, each of which may be assigned to a correspondent, sender of communications, recipient of communications, an entity, or some other participating party in communications, postings and/or correspondence associated with the special container methods and systems of integrated communications. In an example, one format may be assigned to a family member, a second format assigned to a corporation, a third format assigned to a genre of communications (e.g., current news events), and so forth. The special container or letterhead or template format may include attachments. Attachments may include attachments from a single communication channel or multiple communication channels. In embodiments, a user may have multiple containers.

Integrated communications may include various formatting features, such as flexible fonts, attachments, sticky notes, symbols, and other desired features. Flexible fonts may enable a communication, such as an email, to have its text formatted to a preferred style, size or other font characteristic. For example, a user of the integrated communications methods and systems may receive an email in a 10 point font size, and have the font flexibly altered to be a 14 point font size in order to make the email more easily read by the user. The font alteration may be made by a user accessing a menu, a toggle, selecting and icon, or some other facet of the user interface. In embodiments, font or format alteration may be automated, such as to provide a font appropriate for the format of communication channel by which the recipient accesses the communication. For example, if the recipient accesses the communication from the sender in a chat box, the communication can be formatted to fit that format. In embodiments, there may be multiple font configurations, each configuration enabled to permit a sender or a recipient to alter a configuration. Font configurations may be set per message (e.g., email) within a communication channel, or may be set for the entirety of communications occurring within a communication channel.

Integrated communications may include reminders, such as reminders to respond to a communication at a desired time, appointment reminders, or others. Reminders may be set manually or automatically. Reminders may be based on rules, triggers, preferences, or scheduled as needed and appropriate. A reminder may be triggered in all or a subset of the plurality of communications channels, services and applications associated with a container. For example, sending a calendar invitation by email can occur within a container, so that the invitation not only appears on the recipient's main calendar (e.g., Outlook®), but also pops up with appropriate reminders on other calendars and in applications, such as email or Skype, where the user is engaged.

Integrated communications may include the ability to erase a long and repeated communication trail, conversation, and/or log. The ability to erase a long and repeated communication trail, conversation, and/or log may be initiated manually or automatically, and may be based on rules, based on triggers, based on preferences, and so forth.

Integrated communications may include a unique and flexible filing system. In particular, because each communication arrives via the container, which wraps in the various communications channels/applications, formerly disparate communications across different types may now be linked into common threads, and each thread may be accessible in each of the communication channels or applications (or both) that are used at some point in the thread (or optionally even other channels). For example, a communication thread may include a text, an email, a sharing of a link, a video message, a tweet and/or a Facebook post. The thread can be found, within the integrated communications interface, in any of the associated storage systems (e.g., inboxes, file storage locations, saved threads and posts, etc.), and the appropriate channel/application can be initiated in the interface, without switching applications, to view the thread. Similarly, a container can store metadata of various types relating to communications threads, so that a single search can be executed across all of the different communications types, rather than a user having to go from email to Skype® to chat to text, etc. In an example, searching may also yield summary data regarding the communication types used in the past such that a user may see that for a particular correspondent the preferred means of communication appears to be via text messaging given the frequency of past text messages sent. Thus, even though the user may be in need of responding to a voice mail left by the correspondent, the user may opt to reply via text messaging because the summary data yielded from the search indicates that this is the preferred and/or most frequently used communication means for that correspondent. In another example, the searching and the resulting summary data may also allow a user to see his relative usage patterns across a plurality of communication means, such as email, text, Skype, cellular phone, and so forth. Such data may be presented to the user in an interactive user interface that enables the user to specify search criterion. For example, a search may be constrained to email messages with a particular correspondent. The search may inform the user of the average number of characters used by the correspondent in emails sent to the user. The user may use this data to ascertain that the correspondent uses, and by inference is likely to prefer, very short emails containing few characters. This information may allow the user to restrict message length to this user to less than the user's average email length in terms of the number of characters or words used in the body of the email. In another example, the search data may indicate that a particular correspondent appears to most frequently communicate during the hours of 10 am and 1 μm Eastern Time. The user may use this information to then focus communications with the correspondent during this window that appears to be preferred by the correspondent. In embodiments, a tag, label, or the like that is applied by a user to a communication in one of the communication channels in the container can be automatically applied, via the container, to the thread of which the communication is a part, so that the tag appears within the other communication channels when the thread is accessed.

The methods and systems for integrated communications may also integrate with calendars, schedules, meetings, and appointments.

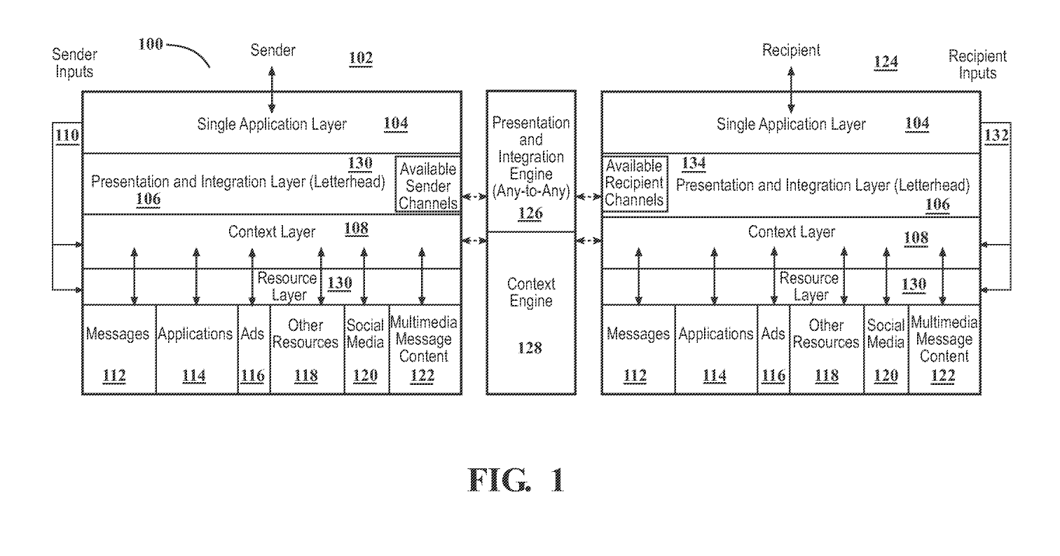

FIG. 1 illustrates an architecture for integrated communications using a multimedia communications system 100. More specifically, FIG. 1 illustrates a communication architecture for integrated communications between a sender and a recipient. The architecture for integrated communications 100 is high level review of the content that is transmitted between a sender and a recipient.

The system 100 according to one embodiment may enable a sender's communication device 102 to communicate with recipient's communication device 124 and may enable recipient and recipient's communication device 124 to communicate with sender's communication device 102. In this particular embodiment, the architecture for methods and systems for integrated communications 100 may include a single application layer 104, presentation and integration layer 106, context layer 108, and resource layer 130.

The single application layer is typically an application such as a mail application that governs the transmission of the communication and includes a medium to manage the content of any communication.

The presentation and integration layer 106 may include presentation capabilities for various available communication channels. Available communication channels may be message channels, application channels, advertisement channels, channels for other resources, social media channels, multimedia message content channels, text channels, video channels, voice/audio channels, and the like. Available channels may also be available sender channels 130 and available recipient channels 134.

Context layer 108 may contain past content related to the specific communication. For instance, the context layer may be a series of past emails or messages that are related to the new email content or message.

Resource layer may include content that is attachable from a database or any other resource such as links within a document, bookmarks, hyperlinks. Resource layer 130 may include resources, such as content. Resources may include message resources 112, application resources 114, advertisement resources 116, other resources 118, social media resources 120, and multimedia message content resources 122, among others desired by the users.

These different communication channels may be made available to the users via an icon or link, or other technique, on the sender's computer. As shown in FIG. 1, the sender 102 may send a message or reply through a variety of sender inputs 110 that includes different layers of the available communication architecture. For example, the sender 102 may access the single application layer 104, such as a text message or an email. Alternatively, the message of the sender 102 or the response may include content from the context layer 108. An example here may be an email thread or a text message thread. The user or sender 102 may also attach a file or other resource from the resource layer 130. As shown, the resource layer 130 may include, or may access, a variety of files or content.

Resource layer 130 may include resources, such as content. Resources may include message resources 112, application resources 114, advertisement resources 116, other resources 118, social media resources 120, and multimedia message content resources 122, among others desired by the users. Sender 102 and recipient 124 may send inputs from the single application layer 104 with the context layer 108 and resource layer 130. Inputs may be sender inputs 110 and recipient inputs 132.

In addition to the above defined layers, the architecture for integrated communications may also include a presentation and integration engine 126, as well as context engine 128. The presentation and integration engine 126 may allow connectivity among available sender channels 130 and available recipient channels 134.

Now turning to the function of receiving a communication from the sender 102 the recipient 124 may reply, using inputs 132 from different layers from the recipient's communication device 124. For example, the sender's 102 message may include a link previously sent and available on the recipient's context layer 108 or in a resource available in the recipient's 124 resource layer 130, as shown.

The single application layer 104 may provide the communication interface for integrated communications 100 between the sender 102 and the recipient 124. The single application layer 104 may also communicate with the presentation and integration layer 106. The presentation and integration layer 106 may communicate with single application layer 104 and context layer 108. The context layer 108 may communicate with resource layer 130, directly with message resources 112, application resources 114, advertisement resources 116, other resources 118, social media resources 120, and multimedia message content resources 122. The resource layer 130 may communicate with the context layer 108, message resources 112, application resources 114, advertisement resources 116, other resources 118, social media resources 120, and multimedia message content resources 122. The resource layer 130 may facilitate communication between the context layer 108 and message resources 112, application resources 114, advertisement resources 116, other resources 118, social media resources 120, and multimedia message content resources 122. The presentation and integration engine 126 may communicate directly to the presentation and integration layer 106, directly to available sender channels 130 or available recipient channels 134, through available sender channels 130 to the presentation and integration layer 106 or through available recipient channels 134 to the presentation and integration layer 106. The presentation and integration engine 126 may also communicate with the context engine 128. The context engine 128 may communicate with the context layer 108, as well as the presentation and integration engine 126.

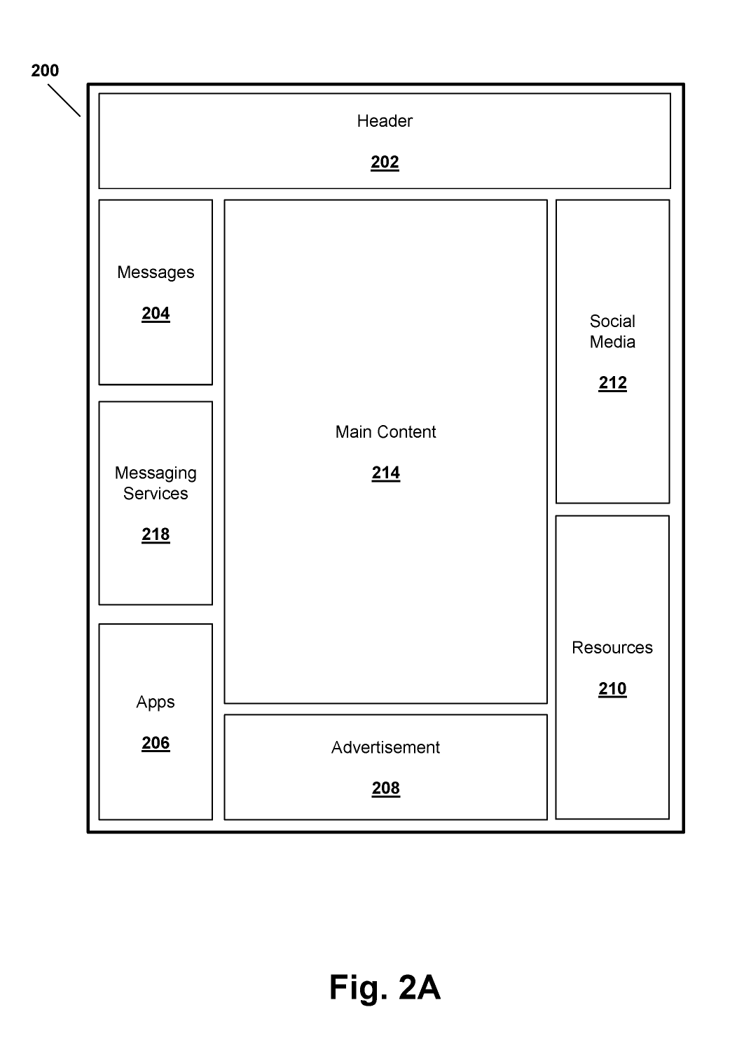

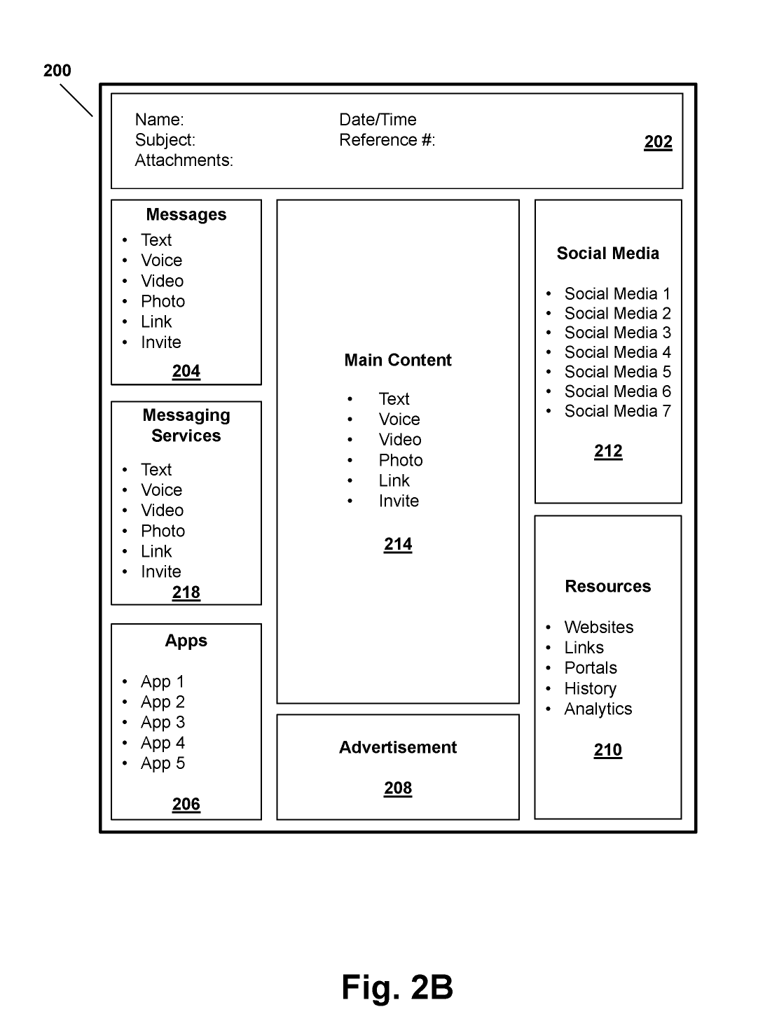

The system 100 allows a wide variety of available channels and resources to be utilized by a sender 102. Thus, a sender 102 of a unified multi-media communications system may wish to access a variety of applications containing information, and may also want to make available his or her information in a variety of these applications to other users. Examples would include users of G-mail+®, Facebook®, Linked-In® and Pinterest®, and many others, such as those mentioned above. Users of the systems and methods described herein may use the multimedia channels to enable friends and associates to view their information or communications via the channels described herein. In other embodiments, a sender 102 sending an email from the multi-media communications system may include links that connect and enable usage of available applications (e.g., social media, VoIP, and the like), including applications that are the preferred types for that specific sender 102. The links and information relating to these applications may be segregated within the message and/or the user interface, as shown for example in FIGS. 2A and 2B. Existing email structures may be used by the system, and additional applications made available to tailor content to specific applications, platforms and/or communications channels and types. For example, an application may enable a user to design letterhead. This letterhead may be designed to be compatible with a plurality of communications platforms. For example, the letterhead may be designed for optimal interoperation with social media platforms, such as Facebook.

Unified multi-media communications are both rich and complex, in the variety of channels and modes of expression available to the sender 102 and to the recipient 124. As noted above, the communications or messages according to the present disclosure may be delivered within a container. This means a data structure that may wrap or contain not only a particular communication, but other communications in a thread (including heterogeneous types, e.g., a text, and email and a tweet), information about channels of communication, applications, and accounts used by a given user for communications, metadata about any of the foregoing, and links or attachments to the communication. In one embodiment, each sender 102 has a client on his or her computer, which may be a desktop application or may be a web application with a browser interface, with various capabilities being served by one or more servers, such as from a cloud. The client may be in communication with a remote server that relays communications to the user/client and also relays communications from the user/client to other users. The richness and variety of communications channels available to the users stem from connections of the client and its server to a great possible variety of applications and resources that are available to the sender/user and to the recipient/user. In embodiments, the status of each channel may be updated in real time so you can see if the sender is, for example, currently logged into an instant messaging account, available via Skype, or accessible through some other means. This may allow a user, when responding, to choose the preferred channel. Updated comments and other data relating to the preferences for a reply channel may be recorded and stored in real time. In an example, a sender may set for the period 9 am to 11:59 am that it is best to reply by return phone call since the user anticipates traveling in a car in this timeframe. Continuing the example, at noon the reply preference may switch to email, since the user anticipates being at their desk and at a computer by this time. In another embodiment, such user preferences may also be set in advance and offline.

A container or wrapper may be enabled by a variety of techniques, such as by defining a set of services that access, such as in a services oriented architecture, connectors, application programming interfaces, and the like, various applications, interfaces, and capabilities of communications channels and applications. For example, a container may include programming code that is adapted to call web sites and feeds (e.g., Facebook® and Twitter®) via links, URLs, domain names, and the like, and present the resulting content in an area of a display, such as defined by an iFrame®, a defined HTML window, or the like. A container may also contain programming code for accessing underlying application capabilities and content, such as accessing an application programming interface (API) for an email client application, a video conferencing application, or similar functionality. A container may also contain programming code for virtualization (e.g., a hypervisor), such as for enabling a virtual machine to access applications residing on servers or client devices. Thus, the container may generally contain a wide range of capabilities for extracting relevant content and interface capabilities from various applications and communications channels. The container may transform content and interfaces to make applications and communications channels suitable for a native environment of the integrated communications systems described herein. This includes making the content and interfaces available in a browser or within an interface similar to a client communications application, such as email, and loading or delivering the content to a server, a client computer, a mobile device, or similar, so that the features and content can be accessed, according to the definitions that define the container, for display on a user's device. Thus, the container may use a variety of data integration and web services integration techniques, as well as metadata management techniques, to enable handling of content and functionality of different types, integrating the same for presentation in a unified interface.

In embodiments, the context engine 128 may determine a communications context of the sender 102 or recipient 124, such as by determining what communications channels (e.g., ports, domains, etc.) are relevant and what communications applications (of various types) are accessible, and either extracting or prompting the sender 102 or recipient 124 to provide account credentials (which may be stored so that single sign-on can be used after initial set up), so that the sender 102 or recipient 124 entire suite of communications capabilities and applications can be presented in and managed by the container.

In embodiments the presentation and integration engine 126 may contain the programming code, data type definitions, sets of services, and other methods and systems for integrating different application capabilities and content from disparate communications channels and applications, then presenting a unified user interface to the sender 102 or recipient 124 with all of the different available communications capabilities described throughout this disclosure.

FIGS. 2A-2B illustrate integrated communications using the unified system described herein. As illustrated in FIG. 2A, an integrated communication 200 may include, in one example of a user interface presentation layer, a header 202, messages 204, applications 206, advertisements 208, resources 210, social media networks 212, and main content 214. As further illustrated in FIG. 2B, header 202 may include, name, subject, attachments, date/time, reference number, and other content as desired. Messages 204 may include text messages, voice messages, video messages, photo messages, link messages, and invite messages, and other messages as desired. Applications 206 may include Join.me®, SnapChat®, Webex®, GotoMeeting®, Skype®, Facetime®, Dropbox®, Google Drive®, Google Hangout®, Spotify®, or other desired applications. Resources 210 may include websites, links, portals, history, analytics, and others as desired. Social media networks 212 may include Facebook®, Twitter®, Pinterest®, Linked-In®, Myspace®, Google+®, YouTube®, and others. Main content 214 may include text or visual content, audio or voice content, video content, photo content, link content, invite content, and so forth. Services may include cloud-based messaging services 218, such as Telegram™.

A message may be sent as an email, an entry in a social media site such as Facebook®, a text message, and so forth. When the recipient opens the message, the content is available to the recipient. If the message is an email, the content may be attached to the email, for example as an attachment, a link within the email, or as an executable icon, for example, opening an application related to a communication channel (e.g., VoIP, social media, and the like).

If the message is sent as a text message, the message may include a link for a recipient 124 to activate. If the message is sent as a voice message, the message may include instructions for the recipient 124 to activate an application on the recipient's communication device to download content from the sender 102. The content may be available to the recipient 124 in any of a variety of ways, as shown in FIG. 2B, the content then accessible to the recipient 124 via the appropriate action.

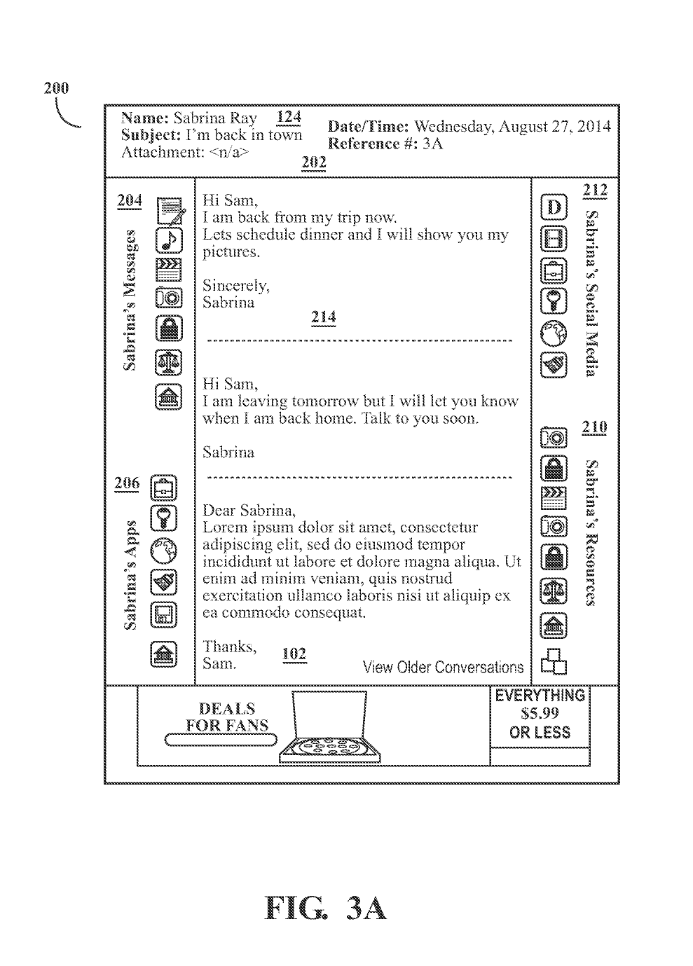

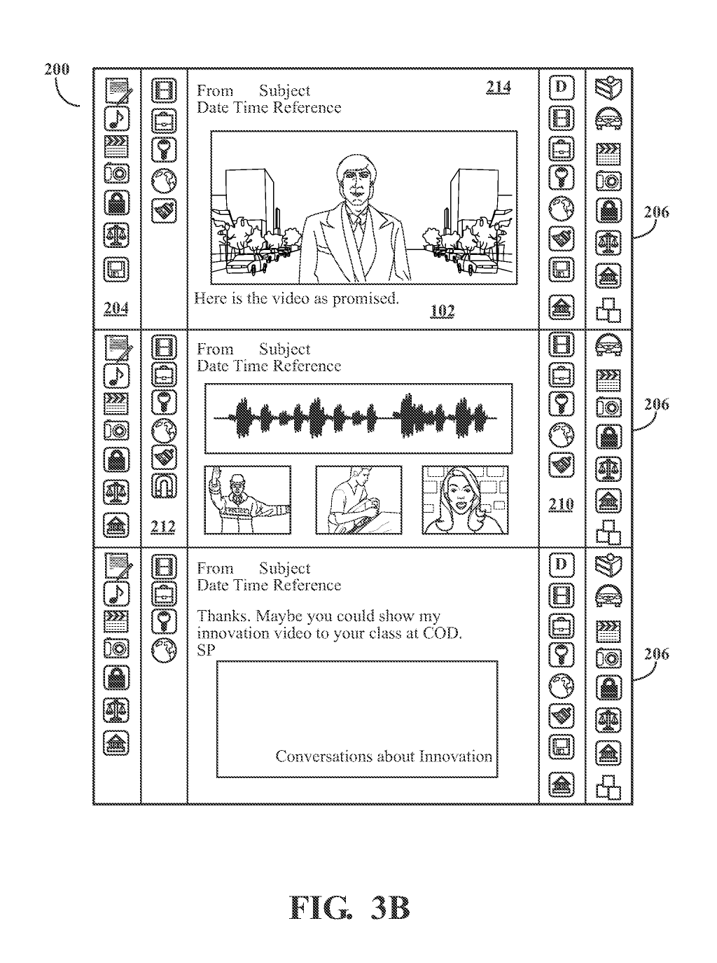

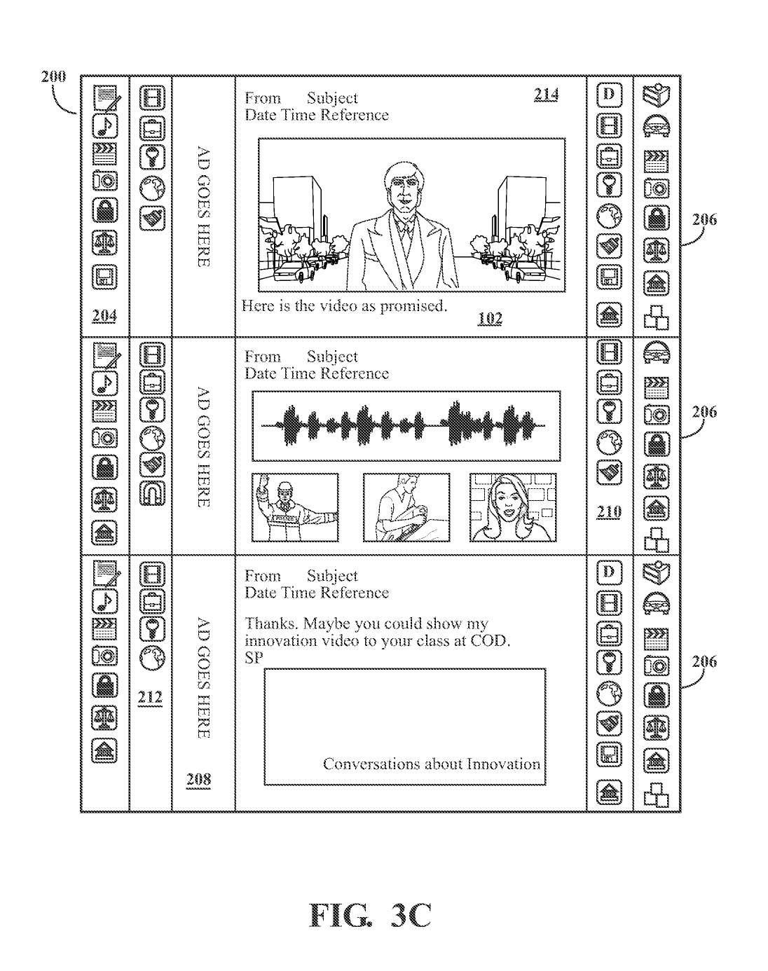

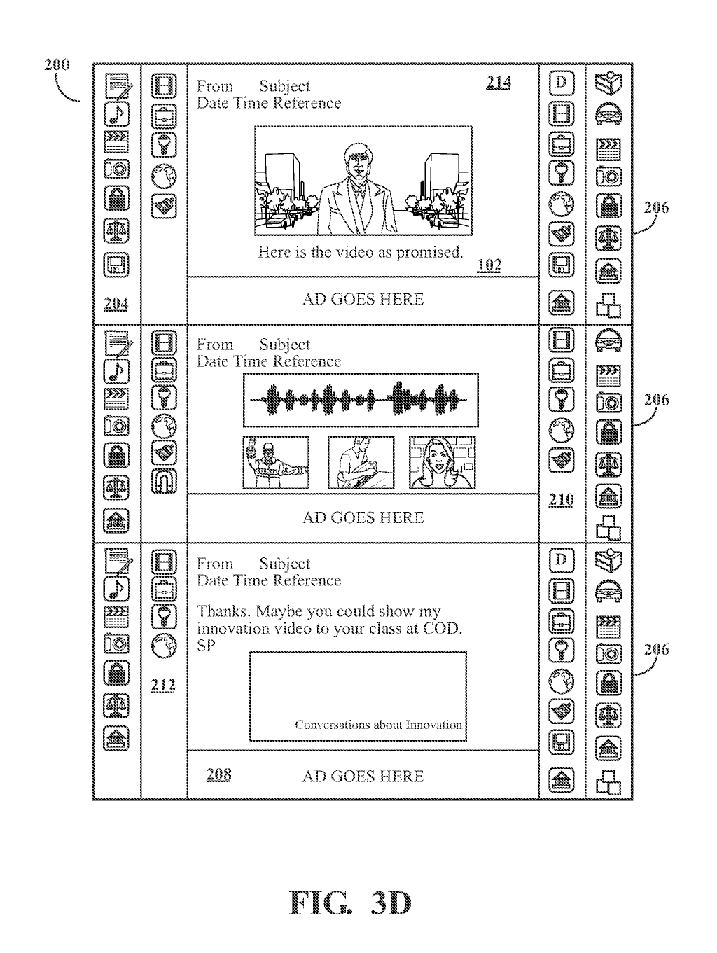

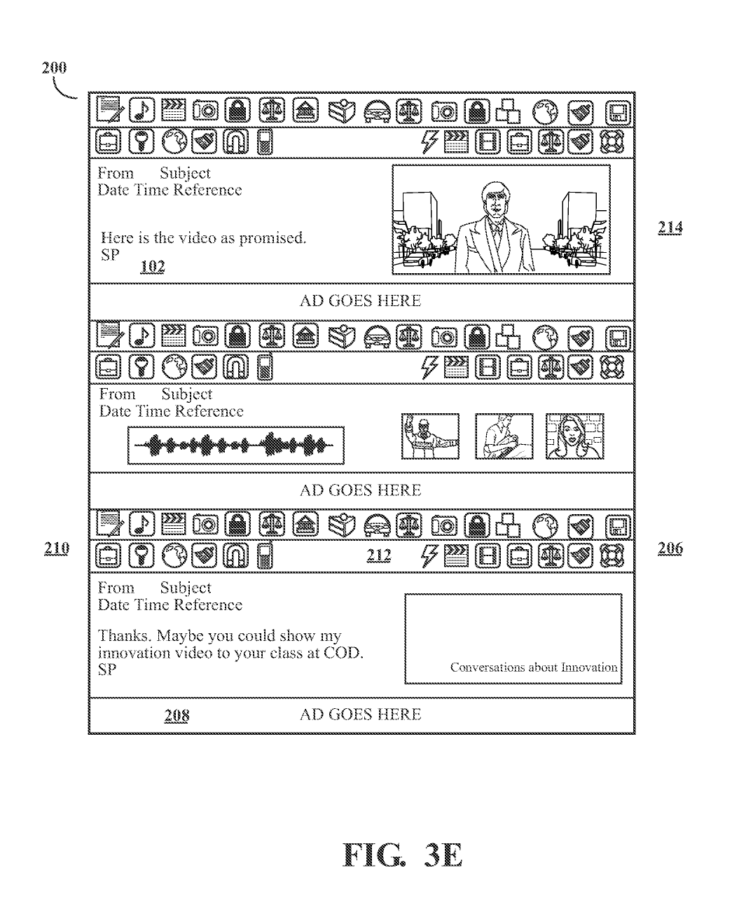

FIGS. 3A-3B illustrate exemplary and non-limiting examples of integrated communications 200 from the point of view of a sender 102 or a recipient 124. As illustrated in FIG. 3A, header 202 may indicate the sender 124, subject, that the message includes no attachments, the date and time, as well as a reference number. Main content 214 may be an email conversation between a sender 102 and recipient 124, as well as allow sender 102 and recipient 124 to view other conversations. As illustrated in FIG. 3A, messages 204 from a sender 102, applications 206 by which a sender 102 can be contacted, social media 212 affiliation icons of sender 102, resources 210 of a sender, as well as an advertisement 208, may also be included. In this example, the sender 102 has sent a message via email and the sender's message includes a plurality of message icons 204 as well as a plurality of social media icons 212. The string of previous messages displayed below the main message 124 includes messages from both sender 102 and recipient 124. In addition, a number of other icons are displayed on the sides, including applications 206 which are available on the sender's communication device, such as Skype®. These suggest other ways available for the sender 102 and recipient 124 to communicate, even if neither the sender 102 nor the recipient 124 wishes to use a particular application to continue the conversation at the moment. There is also a plurality of resource icons 210, which are also available on the sender's communication device. These resources may include, but are not limited to, particular websites of interest, links to websites or other URLs of interest, analytical resources, history resources and portals available on the Internet or otherwise remote. Note that the icons or symbols in FIG. 3A refer only to the sender 102 (“Sabrina”), and that they are labeled as such.

As illustrated in FIG. 3B, main content 214 may be a video message or an audio message 200a sent by a sender 102 to a recipient 124 (not shown), rather than an email or a text message. As illustrated in FIG. 3B, messages 200a, 200c from a sender 102, applications 206a of a sender 102, social media 212a of a sender 102, resources 210a of a sender, may also be included. The content of a message 200a may include a video as shown. FIG. 3B also illustrates a video message thread, in that the top message 200a follows from a previous message 200b with a voiceprint and images and appears to be a message from the “recipient” of the top message to the “sender” of the top message. The third message 200c in the thread again shows a first message from the sender to the recipient. Note that the message resources 204a for the sender 102 are different from the message resources 204b for the recipient 124. Note also that the apps 206a for sender 102 are different from apps 206b for the recipient. In addition, content resources 210a for the sender 102 are different from content resources 210b for the recipient. In addition, social network contacts 212a for sender 102 and different from the social networks 212b of the recipient 124. This suggests that both sender and recipient can share information about how to obtain additional contacts with each other simply by looking at the messages or threads of their various communications. In addition, it suggests that additional resources may be shared by widening the apps or networks used by the other party or parties that one is in communication with.

As illustrated in FIGS. 3C-3E, messages 204 from a sender 102, applications 206 of a sender 102, social media 212 of a sender 102, resources 210 of a sender, and an advertisement 208, may also be included.

When the integrated communication 200 is relayed to the recipient 124, the same set of available content is presented to the recipient 124 in the same or similar fashion as when composed by the sender 102. For example, the sender 102 may send a video, but along with the video the recipient 124 will see all of the sender's social media, email, voice, chat, text and other contact channels, presented in the same user interface as the voice message, so that the recipient 124 can respond with not only a voice message back, but also with any of the other modes of communication used by the original sender 102, without switching to a particular communications application or even leaving the interface in which the integrated communication 200 is presented. The container for the integrated communication 200 passes along the contact information of the user (allowing a simple reply or posting to a thread, or other response that depends on the chosen channel for response) and also manages access to the communications capabilities and content of each of the communications channels and applications. The recipient can reply with a text to a video, and the original sender can reply in turn with an email, and neither of them needs to leave the interface (e.g., within a browser) or launch a new application, to allow an ongoing communications thread that switches from type to type among all of the available channels.

By integrating the various communications channels into a single interface, under control of programming code of one container and one integration and presentation layer, other important capabilities are enabled. For example, communications threads of different types may now be stored (and searched), within a single interface. For example, a single search can pull texts, emails, video messages, voice messages, posts, and tweets that relate to a selected search topic, because communications threads for all of the above are integrated by the integration and presentation layer, and file storage for the container and/or integration and presentation layer can make available the stored content from past communications through a single request. Similarly, searching on a tag or label can retrieve all communications of various types that correspond to threads that contain one or more communications to which the tag or label was applied.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A communications system, comprising:
a first communication device configured to communicate with a second communication device;
a secure container for managing a plurality of heterogeneous communications capabilities of the first communication device wherein upon relaying communication via one of the capabilities, the container accesses content and capabilities for and presents to the second communication device, in a unified user interface, interface features that enable the second communication device to respond to the first communication device via any of the heterogeneous communications capabilities without requiring the user of the unified user interface to navigate to a different application.

2. A system of claim 1, wherein the unified user interface presents contact details for the sender to the recipient for each of the heterogeneous communications capabilities.

3. The system of claim 1, wherein the unified user interface provides a reply function that allows a user to select at least one of the heterogeneous communications capabilities, the selection of which enables the user of the unified user interface to initiate a reply via the selected communications capability that is directed to the appropriate contact of the sender.

4. The system of claim 1, wherein the plurality of heterogeneous communications capabilities are selected from the group consisting of an email application, a browser-based email, a cloud-based messaging service, an in-app communications capability, a social networking application, a voice communication capability, a text messaging capability, an SMS capability, a chat capability, a file sharing capability, a web conferencing capability and a video conferencing capability.

5. A communication system, comprising:
a client comprising a computer with a capability for sending and receiving electronic communications to a communication server for forwarding to at least one other client that comprises a computer with a capability for sending and receiving electronic communications to the communications server; and
a formatted header for sending electronic communications to the at least one other client, wherein the formatted header comprises a plurality of sections, including
at least one section for an address of the at least one other client;
at least one section for a message to the at least one other client; and
a section for a representation of at least two apps capable of communicating the message to the at least one other client.

6. The communications section of claim 5, wherein the at least two apps comprise apps selected from the group consisting of a message app, a social media app, a communication channel app and a resource app.

7. The communications section of claim 5, wherein at least one of the at least two apps is selected from the group consisting of a message app, a channel app, an advertisement channel app, a social media app, a cloud-based messenger app, an in-application communications capability, a multimedia message app, a text app, a video app and a voice or audio app.

8. The communications system of claim 5, further comprising the communications server.

9. The communications system of claim 5, wherein an electronic communication with the formatted header comprises a container for managing a plurality of heterogeneous communications capabilities of the client.

10. The communications system of claim 9, wherein the electronic communications system is adapted so that upon relay of the electronic communication with at least one heterogeneous capability to a recipient, the container accesses content and the at least one heterogeneous capability for is adapted to present to the recipient, in a unified user interface, interface features that enable the recipient to access the electronic communication via at least one of the at least two apps.

11. The communications system of claim 10, wherein the electronic communications system is also adapted to respond to the electronic communication via any of the at least one heterogeneous communications capabilities via the at least one of the at least two apps.

12. A communication system, comprising:
a client comprising a computer with a capability for sending and receiving electronic communications to a communication server for forwarding to at least one other client that comprises a computer with a capability for sending and receiving electronic communications to the communications server; and
a formatted header for sending electronic communications to the at least one other client, wherein the formatted header comprises a plurality of sections, including
at least one section for an address of the at least one other client;
at least one section for a message to the at least one other client; and
at section for at least one representation of at least two apps useful for communicating the message to the at least one other client.

13. A method for selecting a preferred communication channel of a communication recipient, the method comprising:
providing a secure container associated with a first communication device for managing a plurality of heterogeneous communications channels of the first communication device;
storing a communication channel preference, in the secure container, associated with a communication recipient, wherein the stored preference relates to at least one condition placed on at least one of the plurality of heterogeneous communications channels;
presenting the stored communication channel preference to the first communication device upon a user initiating contact with the recipient through one of the plurality of heterogeneous communications channels; and
sending a communication to a second communication device associated with the recipient, wherein the communication is sent over the communication channel stored in the communication channel preference and according to the at least one stored condition.

14. A method for a communication recipient to select a preferred communication channel for sending a reply communication, the method comprising:
providing a secure container associated with a communication device for managing a plurality of heterogeneous communications channels of the communication device;
receiving a message on the communication device from a communication sender, through one of a plurality of heterogeneous communications channels;
storing a communication channel preference, in the secure container, associated with the communication sender, wherein the stored preference is based on at least one condition associated with the received message and a communication channel used by the sender to deliver the received message; and
presenting the stored communication channel preference to the communication device upon a user initiating contact with the communication sender.

15. A method for selecting a preferred communication channel of a communication recipient, the method comprising:
providing a secure container associated with a plurality of communication devices for managing a plurality of heterogeneous communications channels of the plurality of communication devices;
storing a communication channel preference, in the secure container, associated with a correspondent, wherein the stored preference relates to at least one condition placed on at least one of the plurality of heterogeneous communications channels;
receiving a communication from the correspondent on a first communication device among the plurality of communication devices;
presenting at a later time the stored communication channel preference to a second communication device among the plurality of communication devices upon a user initiating contact with the correspondent through one of the plurality of heterogeneous communications channels; and
sending a communication to a communication device associated with the correspondent, wherein the communication is sent over the communication channel stored in the communication channel preference and according to the at least one stored condition.
